(19) United States
(12) Patent Application Publication
(10) Pub. No.: US 2025/0154347 A1
(43) Pub. Date: May 15, 2025

(54) POLYOLEFIN COMPOSITIONS SUITABLE FOR HIGH RESILIENCE FOAMS

(71) Applicant: SABIC GLOBAL TECHNOLOGIES B.V., Bergen op Zoom (NL)

(72) Inventors: Maria SOLIMAN, Selfkant (DE); Dong WAN, Shanghai (CN); Kai GUO, Shanghai (CN); You Jun WU, Shanghai (CN); Hongtao SHI, Shanghai (CN); Ji ZHOU, Shanghai (CN)

(21) Appl. No.: 18/722,021

(22) PCT Filed: Dec. 12, 2022
(86) PCT No.: PCT/EP2022/085295

§ 371 Date: Jun. 20, 2024

(30) Foreign Application Priority Data
Dec. 21, 2021 (WO) PCT/CN2021/140010
Jan. 11, 2022 (EP) 22150952.4

(51) Int. Cl. C08L 23/0807; C08J 9/00; C08J 9/10; C08K 3/22; C08K 3/34; C08K 5/09; C08K 5/14; C08K 5/23; C08L 31/04

(52) U.S. Cl. CPC C08L 23/0815; C08J 9/0028; C08J 9/0066; C08J 9/103; C08K 3/346; C08K 5/09; C08K 5/14; C08K 5/235; C08L 31/04; C08J 2323/20; C08J 2331/04; C08J 2423/06; C08K 2003/2296; C08L 2203/14; C08L 2205/035

(57) ABSTRACT

A polyolefin composition includes: a) ≥65.0 wt. % and ≤94.0 wt. % of an ethylene alpha-olefin co-polymer (A); and b) ≥6.0 wt. % and ≤35.0 wt. % of an ethylene polymer (B). A foamed article contains such a polyolefin composition. The foamed article is obtained by compression foaming a foamable polyolefin composition or a foamable thermoplastic polymer composition. The foamed article can be used for improving the fatigue resistance and mechanical properties of midsole used in a footwear.

### CROSS REFERENCE TO RELATED APPLICATIONS

This application is a National Stage application of PCT/EP2022/085295, filed Dec. 12, 2022, which claims the benefit of European Application No. 22150952.4, filed Jan. 11, 2022, and International Application No. PCT/CN2021/140010, filed Dec. 21, 2021, all of which are incorporated by reference in their entirety herein.

### BACKGROUND

The invention relates to the field of polyolefins and to thermoplastic polymer compositions. The invention also relates to foamable polyolefin compositions and to foamable thermoplastic compositions. The present invention further relates to a foamed article comprising such foamable compositions. The invention is further directed to foamed articles obtained by compression foaming of such foamable compositions. In addition, the invention further describes a method of preparing such foamed articles and to the use of such foamed articles for improving fatigue resistance and mechanical properties of footwear, particularly of midsoles in footwear application.

The sole structure of footwear, such as athletic footwear, generally exhibits a layered configuration that may include a comfort-enhancing insole, a resilient midsole formed from a polymer foam material, and a ground-contacting outsole that provides both abrasion-resistance and traction. The midsole is the primary sole structure element that imparts cushioning and controls foot motions. Conventional polymer foam materials are resiliently compressible, in part, due to the inclusion of a number of open or closed cell architecture typical of a foam material. Of the many commercially available foams, polyolefin foams and polyethylene vinyl/acetate foams are often used in footwear where properties such as cushioning and flexibility are desirable. The polymer foam material for the midsole include polymeric materials such as ethyl vinyl acetate (EVA) copolymers or polyolefin based materials, which compress resiliently under an applied load to provide the desired cushioning and comfort to a user.

Ethylene vinyl acetate (EVA) based foams are soft, light, flexible and cost effective and is often used in entry-level shoes and therefore have a mass scale commercial appeal. Typically for such shoes, midsoles are cut and shaped from flat sheets of EVA foam. However, EVA based foams tend to compress and become flat over time as the air trapped within the foam is squeezed out. Once the EVA foam is compacted, it does not return to its original shape and no longer provides the desired cushioning. On the other hand, polyolefin foams have a lower shrinkage and compression set at elevated temperatures, when compared with poly(ethylene/vinyl acetate) foams and therefore offer effective alternate material solutions. Yet another material, which may be used for midsole application, are the Olefin Block Copolymers (OBCs), which impart improved compression set and shrinkage at elevated temperatures, compared with conventional random polyolefin elastomers (POE). Olefin block copolymers (OBC) are structurally different from traditional polyolefin elastomers (POE), which in turn results in Olefin Block Copolymers having a very different physical characteristics of melting temperature, tensile properties as compared to traditional polyolefin elastomers. Although, the materials such as Olefin Block Copolymers (OBCs), polyolefins and poly(ethylene/vinyl acetate) are promising with regard to their compression setting and other foam related properties, the mechanical performance (tensile or tear strength) of such materials may be further improved while retaining foam properties in order to enhance the durability and comfort of the footwear.

### SUMMARY

It is an object of the present invention to provide a polymer compositions and in particular foamable polymer compositions, which can be used in foam materials in order to improve both mechanical (tensile and tear) as well foam related properties (compression set, resilience) as may be required for footwear applications.

Accordingly, one or more objectives of the present invention is achieved by a polyolefin composition comprising:
a) ≥65.0 wt. % and ≤94.0 wt. %, preferably ≥75.0 wt. % and ≤90.0 wt. %, preferably ≥80.0 wt. % and ≤90.0 wt. %, of an ethylene alpha-olefin co-polymer (A), with regard to the total weight of the polyolefin composition; and
b) ≥6.0 wt. % and ≤35.0 wt. %, preferably ≥10.0 wt. % and ≤25.0 wt. %, preferably ≥10.0 wt. % and ≤20.0 wt. %, of an ethylene polymer (B), with regard to the total weight of the polyolefin composition.

### DETAILED DESCRIPTION

Preferably, the polyolefin composition comprises:
a) ≥65.0 wt. % and ≤94.0 wt. %, preferably ≥75.0 wt. % and ≤90.0 wt. %, preferably ≥80.0 wt. % and ≤90.0 wt. %, of an ethylene alpha-olefin co-polymer (A), with regard to the total weight of the polyolefin composition, preferably wherein the ethylene alpha-olefin co-polymer (A) comprises polymeric units derived from ethylene and one or more alpha-olefin having 3-12 carbon atoms, preferably selected from propylene, 1-butene, 1-hexene, 4-methyl-1-pentene, 1-octene, or combinations thereof, more preferably the alpha-olefin is selected from 1-butene, 1-hexene or 1-octene, further wherein the ethylene alpha-olefin co-polymer has at least one of:
   i. a peak melting temperature of ≥35° C. and ≤90° C., preferably of ≥40° C. and ≤60° C., ≥40° C. and ≤50° C., ≥55° C. and ≤75° C., or ≥55° C. and ≤65° C. when determined in accordance with ASTM D3418-15, using Differential Scanning calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle;
   ii. ≥5.0 wt. % and ≤45.0 wt. %, preferably ≥28.0 wt. % and ≤42.0 wt. %, preferably ≥36.0 wt. % and ≤42.0 wt. %, of polymeric units derived from the one or more alpha-olefins having 3-12 carbon atoms, with regard to the total weight of the ethylene alpha-olefin co-polymer;
   iii. a melt flow rate (MFR) of ≥0.10 g/10 min and ≤30.0 g/10 min, preferably ≥0.10 g/10 min and ≤10.0 g/10 min, preferably ≥0.10 g/10 min and ≤1.0 g/10 min, preferably ≥0.10 g/10 min and ≤1.0 g/10 min, preferably ≥0.30 g/10 min and ≤0.60 g/10 min, when determined at 190° C. at 2.16 kg load in accordance with ASTM D1238 (2013); and
   iv. a density of ≥850 kg/m³ and ≤900 kg/m³, preferably ≥857 kg/m³ and ≤885 kg/m³, preferably ≥870 kg/m³ and ≤880 kg/m³, when determined in accordance with ASTM D792 (2008);
and
b) ≥6.0 wt. % and ≤35.0 wt. %, preferably ≥10.0 wt. % and ≤25.0 wt. %, preferably ≥10.0 wt. % and ≤20.0 wt. %, of an ethylene polymer (B), with regard to the total weight of the polyolefin composition, wherein the ethylene polymer (B) has at least one of:
   i. a density of ≥940 kg/m³ and ≤980 kg/m³, preferably ≥945 kg/m³ and ≤970 kg/m³, when determined in accordance with ASTM D1505-10 (2018) at 23° C.; and
   ii. a melt flow rate (MFR) of ≥0.03 g/10 min and ≤40.0 g/10 min, preferably ≥0.10 g/10 min and ≤10.0 g/10 min, preferably ≥0.10 g/10 min and ≤1.0 g/10 min, preferably ≥0.10 g/10 min and ≤0.8 g/10 min, preferably ≥0.20 g/10 min and ≤0.50 g/10 min, when determined at 190° C. at 2.16 kg load in accordance with ASTM D1238 (2013).

Preferably, the ethylene alpha-olefin co-polymer (A) comprises ethylene and one or more alpha-olefin selected from propylene, 1-butene, 1-hexene, 4-methyl-1-pentene, 1-octene, or combinations thereof. Preferably the alpha-olefin is selected from 1-butene, 1-hexene or 1-5 octene. More preferably the ethylene alpha-olefin co-polymer (A) is a copolymer of ethylene and 1-octene. In certain embodiments of the invention, the polymeric units that are derived from one or more alpha-olefins may be present in a suitable amount in the ethylene alpha-olefin copolymer (A) in order to impart the desired balance of crystalline and amorphous phase in the copolymer. The polymeric units derived from ethylene and the alpha-olefin may for example be determined via ¹³C NMR spectrometry according to the method presented in JAPS, Vol. 42, pp. 399-408, 1991.

Accordingly, the ethylene alpha-olefin co-polymer (A) may for example have:
i. a peak melting temperature of ≥40° C. and ≤60° C., preferably ≥40° C. and ≤50° C., when determined in accordance with ASTM D3418-15, using Differential Scanning calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle;
ii. polymeric units derived from one or more alpha-olefins of ≥28.0 wt. % and ≤42.0 wt. %, preferably ≥36.0 wt. % and ≤42.0 wt. %, with regard to the total weight of the ethylene alpha-olefin co-polymer (A);
iii. a Mooney viscosity (ML 1+4, 121° C.) of ≥30.0 MU and ≤80.0 MU, when determined in accordance with ASTM D1646-17;
iv. a tear strength (Type C) of ≥25.0 kN/m and ≤60.0 kN/m, preferably ≥40.0 kN/m and ≤60.0 kN/m, when determined in accordance with ASTM D624;
v. a melt flow rate (MFR) of ≥0.10 g/10 min and ≤1.0 g/10 min, preferably ≥0.30 g/10 min and ≤0.60 g/10 min, when determined at 190° C. at 2.16 kg load in accordance with ASTM D1238 (2013); and
vi. a density of ≥870 kg/m³ and ≤880 kg/m³, when determined in accordance with ASTM D792 (2008).

The ethylene polymer (B) may for example is a high density polyethylene (HDPE). Preferably, the ethylene polymer (B) has:
i. a density of ≥945 kg/m³ and ≤970 kg/m³, when determined in accordance with ASTM D1505 (2018);
ii. a melt flow rate (MFR) of ≥0.10 g/10 min and ≤10.0 g/10 min, preferably ≥0.10 g/10 min and ≤0.80 g/10 min, preferably ≥0.20 g/10 min and ≤0.50 g/10 min, when determined at 190° C. at 2.16 kg load in accordance with ASTM D1238 (2013); and
iii. a peak melting temperature of ≥125° C. and ≤136° C., preferably ≥129° C. and ≤133° C., when determined in accordance with ASTM D3418-15, using Differential Scanning calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle.

Without being bound by any specific theory the polyolefin composition has a suitable blend of the lower melting point ethylene alpha-olefin co-polymer (A) with a high melting point ethylene polymer (B) in order to impart the desired processing characteristics to such a composition.

Further, the polyolefin composition may have a suitable density and flow property in order to impart the desired balance of mechanical and resilience properties to a foam composition. For example, the polyolefin composition may desirably have (i) a density of ≥870 kg/m³, when measured in accordance with ASTM D792 (2008), and (ii) a melt flow rate (MFR) of <1.0 g/10 min, when determined at 190° C. at 2.16 kg load in accordance with ASTM D1238 (2013).

Accordingly, the polyolefin composition may for example have:
a) a density of ≥870 kg/m³, preferably ≥870 kg/m³ and ≤900 kg/m³, preferably ≥870 kg/m³ and ≤880 kg/m³ when measured in accordance with ASTM D792 (2008); and
b) a melt flow rate (MFR) of ≥0.35 and ≤0.80 g/10 min, preferably ≥0.40 and ≤0.60 g/10 min, when determined at 190° C. at 2.16 kg load in accordance with ASTM D1238 (2013).

In some embodiments of the invention, the invention relates to a method of preparing the polyolefin composition of the present invention. The method for example comprises the steps of:
a) providing to an extruder a set of ingredients comprising the ethylene alpha-olefin co-polymer (A), the ethylene polymer (B), and optionally additives comprising a blowing agent, a cross-linking agent, a mineral filler, a processing aid, and a heat transfer agent; and
b) extruding the set of ingredients at a melt temperature of ≤180° C., preferably ≤170° C. and forming the composition.

The ingredients may be dry blended to form a blended mixture outside the extruder and subsequently the blended mixture may be introduced inside the extruder via the hoper of the extruder. Alternatively, the set of ingredients may be introduced individually into the extruder via the hopper such that the ingredients are blended inside the extruder prior to being extruded. The extrusion step may for example involves melt blending the set of ingredients at a suitable melt temperature. Preferably, the extruder die temperature is maintained at a temperature of ≤180° C., preferably at a temperature of about 160° C. The screw speed during extrusion may be configured to be maintained at any suitable speed for example a screw speed of 300 RPM. The extruder torque may be maintained at 62%.

In some embodiments of the invention, the invention is directed to a foamable polyolefin composition. The expression “foamable” as used herein means a composition that is capable of being foamed under suitable conditions of foaming.

The foamable polyolefin composition may for example comprise:
a) ≥70.0 wt. %, preferably ≥80.0 wt. %, of the polyolefin composition of the present invention; and
b) ≤30.0 wt. %, preferably ≤20.0 wt. %, of one or more additives selected from a blowing agent, a cross-linking agent, a mineral filler, a processing aid, a heat transfer agent, or combinations thereof, preferably the foamable polyolefin composition further comprises ≤25.0 wt. %, preferably ≤20.0 wt. %, with regard to the total weight of the foamable polyolefin composition, of additives comprising a blowing agent, a cross-linking agent, a mineral filler, a processing aid, and a heat transfer agent;
   with regard to the total weight of the foamable polyolefin composition. Preferably, the content of polyolefin composition present in the foamable polyolefin composition, may be maintained above 80.0 wt. % with regard to the total foamable polyolefin composition.

Preferably, the foamable polyolefin composition comprises:
a) ≥65.0 wt. % and ≤80.0 wt. %, of the ethylene alpha-olefin co-polymer (A);
b) ≥6.0 wt. % and ≤20.0 wt. %, of the ethylene polymer (B); and
c) ≥0.5 wt. % and ≤30.0 wt. %, preferably ≥10.0 wt. % and ≤20.0 wt. %, of additives comprising a blowing agent, a cross-linking agent, a mineral filler, a processing aid, and a heat transfer agent;
   with regard to the total weight of the foamable polyolefin composition. Alternatively, the foamable polyolefin composition comprises ≥1.0 wt. % and ≤25.0 wt. %, preferably ≥5.0 wt. % and ≤20.0 wt. %, preferably ≥8.0 wt. % and ≤20.0, of additives comprising a blowing agent, a cross-linking agent, a mineral filler, a processing aid, and a heat transfer agent, with regard to the total weight of the foamable polyolefin composition.

Preferably, the foamable polyolefin composition further comprises at least one of:
a) ≥65.0 wt. % and ≤80.0 wt. %, of the ethylene alpha-olefin co-polymer (A);
b) ≥6.0 wt. % and ≤20.0 wt. %, of the ethylene polymer (B);
c) ≥0.10 wt. % and ≤25.0 wt. %, preferably ≥10.0 wt. % and ≤18.0 wt. %, of a mineral filler, wherein preferably the mineral filler is selected from talc, calcium carbonate, or combinations thereof;
d) ≥0.1 wt. % and ≤2.0 wt. %, preferably ≥0.1 wt. % and ≤1.0 wt. %, of a cross-linking agent; wherein preferably the cross-linking agent is an organic peroxide selected from 2,5-dimethyl-2,5-di(t-butylperoxy) hexane, 3-di-t-butylperoxide, t-dicumylperoxide, 2,5-dimethyl-2,5-di(t-butylperoxy)hexyne, dicumylperoxide, α,α′-bis(t-butylperoxyisopropyl)benzene, n-butyl-4,4-bis(t-butylperoxy)butane, 2,2-di(tert-butylperoxy)butane, 1,1-bis(t-butylperoxy)cyclohexane, tertiarybutylperoxy-2-ethylhexyl carbonate, t-butylperoxybenzoate, 1,6-di(t-butylperoxycarbonyloxy) hexane, preferably the cross-linking agent is dicumylperoxide;
e) ≥0.1 wt. % and ≤5.0 wt. %, preferably ≥1.0 wt. % and ≤2.0 wt. %, of a blowing agent; preferably the blowing agent is selected from azodicarbonamide, isobutane, n-butane, iso-pentane, n-pentane, LPG, a fluorohydrocarbon; preferably the blowing agent is azodicarbonamide;
f) ≥0.1 wt. % and ≤2.0 wt. %, preferably ≥0.1 wt. % and ≤1.0 wt. %, of a processing aid, preferably the processing aid is stearic acid;
g) ≥0.1 wt. % and ≤2.0 wt. %, preferably ≥0.1 wt. % and ≤1.0 wt. %, of a heat transfer agent, preferably the heat transfer agent is zinc oxide; and
h) combinations thereof;
   with regard to the total weight of the foamable polyolefin composition.

Alternatively, one or more objectives of the present invention is achieved by a thermoplastic polymer composition comprising the polyolefin composition of the present invention. For example, in some preferred embodiments of the invention, the thermoplastic polymer composition, comprises:
a) ≥55.0 wt. % and ≤90.0 wt. %, preferably ≥60.0 wt. % and ≤88.0 wt. %, of an ethylene vinyl acetate copolymer (EVA); and
b) ≥10.0 wt. % and ≤45.0 wt. %, preferably ≥12.0 wt. % and ≤40.0 wt. %, of the polyolefin composition of the present invention,
   with regard to the total weight of the thermoplastic polymer composition.

The ethylene vinyl acetate copolymer (EVA) may for example have:
a) a peak melting temperature of ≥60° C. and ≤99° C., preferably ≥70° C. and ≤90° C., preferably ≥80° C. and ≤85° C., when determined in accordance with ASTM D3418-15, using Differential Scanning calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle;
b) a density of ≥926 kg/m³ and ≤974 kg/m³, preferably ≥935 kg/m³ and ≤950 kg/m³, when determined in accordance with ASTM D792 (2008); and
c) ≥5.0 wt. % and ≤40.0 wt. %, preferably ≥10.0 wt. % and ≤35.0 wt. %, preferably ≥18.0 wt. % and ≤28.0 wt. %, of polymeric units derived from vinyl acetate, with regard to the total weight of the ethylene vinyl acetate copolymer (EVA).

In some embodiments of the invention, the invention is directed to a foamable thermoplastic polymer composition comprising the thermoplastic polymer composition of the present invention. The expression “foamable” as used herein means a composition that is capable of being foamed under suitable conditions of foaming. For example, the foamable thermoplastic polymer composition may comprise:
a) ≥65.0 wt. %, preferably ≥70.0 wt. %, the thermoplastic polymer composition of the present invention; and
b) ≤35.0 wt. %, preferably ≤30.0 wt. %, of one or more additives selected from a blowing agent, a cross-linking agent, a mineral filler, a processing aid, a heat transfer agent, or combinations thereof, preferably the foamable thermoplastic polymer composition further comprises ≤35.0 wt. %, preferably ≤30.0 wt. %, of additives comprising a blowing agent, a cross-linking agent, a mineral filler, a processing aid, and a heat transfer agent;
   with regard to the total weight of the foamable thermoplastic composition.

Preferably, the foamable thermoplastic polymer composition comprises at least one of:
a) ≥0.1 wt. % and ≤25.0 wt. %, preferably ≥10.0 wt. % and ≤18.0 wt. %, of a mineral filler, wherein preferably the mineral filler is selected from talc, calcium carbonate, or combinations thereof;
b) ≥0.1 wt. % and ≤2.0 wt. %, preferably ≥0.1 wt. % and ≤1.0 wt. %, of a cross-linking agent; wherein preferably the cross-linking agent is an organic peroxide selected from 2,5-dimethyl-2,5-di(t-butylperoxy) hexane, 3-di-t-butylperoxide, t-dicumylperoxide, 2,5-dimethyl-2,5-di(t-butylperoxy)hexyne, dicumylperoxide, α,α′-bis(t-butylperoxyisopropyl)benzene, n-butyl-4,4-bis(t-butylperoxy)butane, 2,2-di(tert-butylperoxy)butane, 1,1-bis(t-butylperoxy)cyclohexane, tertiarybutylperoxy-2-ethylhexyl carbonate, t-butylperoxybenzoate, 1,6-di(t-butylperoxycarbonyloxy) hexane, preferably the cross-linking agent is dicumylperoxide;
c) ≥0.1 wt. % and ≤5.0 wt. %, preferably ≥1.0 wt. % and ≤2.0 wt. %, of a blowing agent; preferably the blowing agent is selected from azodicarbonamide, isobutane, n-butane, iso-pentane, n-pentane, LPG, a fluorohydrocarbon; preferably the blowing agent is azodicarbonamide; and/or
d) ≥0.1 wt. % and ≤2.0 wt. %, preferably ≥0.1 wt. % and ≤1.0 wt. %, of a processing aid, preferably the processing aid is stearic acid;
e) ≥0.1 wt. % and ≤2.0 wt. %, preferably ≥0.1 wt. % and ≤1.0 wt. %, of a heat transfer agent, preferably the heat transfer agent is zinc oxide; and
f) combinations thereof;
   with regard to the total weight of the foamable thermoplastic polymer composition.

Preferably, the foamable thermoplastic polymer composition comprises or consists of:
a) ≥55.0 wt. % and ≤90.0 wt. %, preferably ≥60.0 wt. % and ≤85.0 wt. %, of the ethylene vinyl acetate copolymer (EVA);
b) ≥9.0 wt. % and ≤15.0 wt. %, preferably ≥10.0 wt. % and ≤15.0 wt. %, of the ethylene alpha-olefin co-polymer (A);
c) ≥1.0 wt. % and ≤10.0 wt. %, preferably ≥1.0 wt. % and ≤5.0 wt. %, of the ethylene polymer (B); and
d) ≥0.5 wt. % and ≤35.0 wt. %, preferably ≥10.0 wt. % and ≤20.0 wt. %, of additives comprising a blowing agent, a cross-linking agent, a mineral filler, a processing aid, and a heat transfer agent;
   with regard to the total weight of the foamable thermoplastic polymer composition. Preferably, the foamable thermoplastic polymer composition comprises ≤15.0 wt. % of the ethylene alpha-olefin co-polymer (A) derived from the polyolefin composition, for the foam to have a suitable balance of foam properties (e.g. compression set, resilience) and mechanical properties (e.g. tensile properties).

In a preferred embodiment of the invention, the foamable thermoplastic polymer composition comprises or consists of:
a) ≥55.0 wt. % and ≤70.0 wt. % of the ethylene vinyl acetate copolymer (EVA);
b) ≥9.0 wt. % and ≤15.0 wt. %, of the ethylene alpha-olefin co-polymer (A);
c) ≥1.0 wt. % and ≤5.0 wt. % of the ethylene polymer (B);
d) ≥12.0 wt. % and ≤18.0 wt. %, of any one of talc or calcium carbonate;
e) ≥0.1 wt. % and ≤2.0 wt. %, of dicumylperoxide;
f) ≥0.1 wt. % and ≤5.0 wt. %, of azodicarbonamide;
g) ≥0.1 wt. % and ≤2.0 wt. %, of stearic acid; and
h) ≥0.1 wt. % and ≤2.0 wt. % of zinc oxide;
   with regard to the total weight of the foamable thermoplastic polymer composition.

The crosslinking agent suitable for use in the foamable polyolefin composition or the foamable thermoplastic polymer composition, may be so selected with the consideration of having a suitable half-life time. For example, if the half-life time of the organic peroxide at a particular temperature is too low, then the composition may be prematurely cross-linked thereby adversely affecting its processability during the compression foaming process. On the other hand, if the half-life time of the organic peroxide is high, the overall processing efficiency is reduced during the compression foaming process resulting in increased production cost.

Accordingly, the crosslinking agent may be an organic peroxide having a half-life time of ≥3.0 minutes and ≤85.0 minutes, preferably ≥10.0 minutes and ≤70.0 minutes, preferably ≥ 12.0 minutes and ≤25.0 minutes, when measured using the equation t_{0.5}=ln (2)/k, where t_{0.5} is the half life time and ‘k’ is the reaction rate constant determined using the Arrhenius Equation at a temperature of 140° C.

In some preferred embodiments of the invention, the invention further relates to a foamed article comprising the polyolefin composition of the present invention or the thermoplastic polymer composition of the present invention.

In some embodiments of the invention, the invention is directed to a foamed article obtained by a process comprising the step of compression foaming the foamable polyolefin composition of the present invention or by compression foaming the foamable thermoplastic polymer composition of the present invention.

In some embodiments of the invention, the invention is directed to a method of preparing the foamed article of the present invention. For example, the method for preparing such a foamed article may comprise:
a) providing a foam precursor formulation comprising the polyolefin composition of the present invention, a mineral filler, a blowing agent, a cross-linking agent, a heat transfer agent, a processing aid, and optionally an ethylene vinyl acetate copolymer (EVA); and
b) subjecting the foam precursor formulation to compression foaming to obtain the foamed article.

In some preferred embodiments of the invention, the foam precursor formulation may be prepared by a method comprising:
a) mixing a set of ingredients comprising the polyolefin composition of the present invention, the mineral filler, the heat transfer agent, the processing aid, the crosslinking agent, the blowing agent, and optionally the ethylene vinyl acetate copolymer (EVA), and forming a precursor mixture; and
b) milling the precursor mixture and forming the foam precursor formulation.

In some preferred embodiments of the invention, when the foamed article is prepared from the foamable thermoplastic polymer composition, ethylene vinyl acetate copolymer (EVA) is used for preparing the foam precursor formulation.

The milling process may for example involve an open milling process, which is carried out at any temperature of ≥95° C. and ≤130° C. The foam precursor formulation may be converted to a sheet and subsequently subjected to conditions suitable for compression foaming. Such conditions of compression foaming may include compression foaming the foam precursor formulation at any temperature between ≥150° C. and ≤180° C., under any clamping pressure between ≥10 MPa and ≤30 MPa. The foamed article once obtained may be subjected to skiving to remove any unfoamed portion.

The foamed article demonstrated excellent balance of foam properties and mechanical properties. For example, in some embodiments of the present invention, a foamed article having an Asker Type C Hardness of 55 units as determined in accordance with ASTM D2240-15 (2021) and comprising the thermoplastic polymer composition, is characterized by:
a) a Compression Set (C-Set) of ≥35.0% and ≤45.0%, when measured in accordance with ASTM D395-18 method B under conditions of 50% compression at 50° C. for 6 hours with a recovery time of 30 minutes;
b) a resilience of ≥55.0%, when determined using the Falling Ball Rebound Test in accordance with ASTM D2632-15 (2019); and
c) a tensile strength of ≥22.0 MPa and ≤40.0 MPa, when determined in accordance with ASTM D412-16 (2021) Test Method A.

In another embodiment of the present invention, a foamed article having an Asker Type C Hardness of 45 units as determined in accordance with ASTM D2240-15 (2021) and comprising the polyolefin composition, is characterized by:
a) a Compression Set (C-Set) of ≥35.0% and ≤65.0%, when measured in accordance with ASTM D395-18 method B under conditions of 50% compression at 50° C. for 6 hours with a recovery time of 30 minutes;
b) a resilience of ≥58.0%, when determined using the Falling Ball Rebound Test in accordance with ASTM D2632-15 (2019); and
c) a tensile strength of ≥17.5 MPa and ≤30.0 MPa, when determined in accordance with ASTM D412-16 (2021) Test Method A.

Accordingly, in some preferred embodiments of the invention, the invention is directed to an article comprising the foamed article of the present invention wherein preferably the article is a footwear midsole. Although the preferred application of such foamed articles is targeted for footwear midsole, the foamed article may be used in other application such as sportswear goods, consumer electronics, house hold appliances.

Specific examples demonstrating some of the embodiments of the invention are included below. The examples are for illustrative purposes only and are not intended to limit the invention. It should be understood that the embodiments and the aspects disclosed herein are not mutually exclusive and such aspects and embodiments can be combined in any way. Those of ordinary skill in the art will readily recognize parameters that can be changed or modified to yield essentially the same results.

For Examples II-IV, the testing procedures on foam sample specimens are as provided below:

Falling Ball Rebound Test (Resilience Test): The resiliency test was conducted in accordance with ASTM D2632-15 (2019). A ⅝″ diameter steel ball was dropped from a height of 500 mm onto the foam sample (before and after aging) to determine the percentage Rebound. The percentage Rebound is calculated as rebound height (in mm)×100/500.

Compression Set test: Compression Set (C-Set) was measured in accordance with ASTM

D395-18 method B under conditions of 50% compression at 50° C. for 6 hours with a recovery time of 30 minutes. Two buttons were tested per foam and the average reported. The compression set was calculated by using the following equation provided below, where T₀ is the interval distance of the apparatus, T₁ is the sample thickness before test and T₂ is the sample thickness after test:

Compression set=(T₁−T₂)/(T₁−T₀)*100%

Asker Type C Hardness: The Asker Type C Hardness test was determined in accordance with ASTM D2240-15 (2021). The hardness was an average of five readings (5 seconds latency) measured across the surface of the sample and measured again after aging for 40 minutes at both 70° C. and 100° C.

Tensile Strength and Tear Strength: Tensile strength was determined in accordance with ASTM D412-16 (2021) Test Method A, while Tear Strength was determined in accordance with ASTM D624-00 (2020). For Tear strength, ASTM D624 (Tear, Type C) mechanical property test at 20 inches/minute was used. The sample thickness was approximately 3 mm. The split tear strength was measured by using a specimen with the dimension of 6″ (length)*1″ (width)*0.4″ (thickness) and the notch depth of 1˜1.5″ at the testing speed of 2 inches/minute.

Shrinkage Test: was determined in accordance with the standard SATRA TM70. This test standard is intended to determine the degree of shrinkage of cellular soling materials when they are subjected to heat, in shoemaking or in service. The test involves using a foam specimen, where pairs of marks are made on each principal surface of the test specimen. The distance between the marks was measured before and after heating (annealing) the test specimens under specified conditions, to determine the percentage shrinking of the test specimen. For the purpose of the current test, sample specimen of dimension 10 cm×10 cm was taken and the change in dimension of the specimen was determined before and after subjecting the sample specimen to a heat treatment at 70° C. for 40 minutes.

Peel Strength was measured in accordance with BS 5131-5.4:1978. The standard provides methods of test for footwear and footwear materials.

### Example I

Purpose: Providing a set of polyolefin compositions (inventive polyolefin compositions) comprising the ethylene alpha-olefin co-polymer (A) and the ethylene polymer (B), blended together in various proportions, in accordance with an embodiment of the present invention.

Ingredients used for preparing the polyolefin compositions: The following set of ingredients were used:

TABLE 1

| Material Type | Grade Name | Properties |
|---|---|---|
| Ethylene alpha-olefin co- | C0570D - FORTIFY ™ | MFR 0.5 g/10 min; T_{p, m} 59° |
| polymer (A) also referred to as | Polyolefin Elastomer (POE) | C.; Density 868 kg/m³ |
| “POE” | (from SABIC) | |
| Ethylene polymer (B) | HDPE - B5429D | MFR 0.3 g/10 min; Density |
| also referred as “HDPE” | (from SABIC) | 954 kg/m³ |
| Ethylene polymer (B) | HDPE - CC453 | MFR 4.0 g/10 min; Density |
| also referred as “HDPE” | (from SABIC) | 953 kg/m³ |
| Ethylene alpha-olefin co- | C0560D FORTIFY ™ | MFR 0.5 g/10 min; T_{p, m} 45° |
| polymer (A) also referred as | Polyolefin Elastomer (POE) | C.; Density: 863 kg/m³ |
| “POE” | | |
| Olefin Block Copolymer (OBC) | INFUSE ™ 9107 | MFR 1.02 g/10 min; |
| also referred as “OBC” | | Density: 866 kg/m³ |

Wherein:
MFR is the melt flow rate, as determined according to ASTM D1238 (2013) at 190° C., 2.16 kg;
T_{p,m} is the peak melting temperature, as determined according to ASTM D3418-15, using Differential Scanning calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle; and
Density is determined in accordance with ASTM D792 (2008).

Method of preparation: For each set of polyolefin compositions other than the comparative polyolefin compositions POC6 and POC7, the ingredients were dry blended to form a blended mixture and subsequently the blended mixture was introduced inside the extruder via the hoper of the extruder. During the extrusion step the die temperature was maintained at a temperature of 160° C. The screw speed during extrusion was configured at a screw speed of 300 RPM. The extruder torque was maintained at 62%. The extruder used was a twin-screw extruder from Coperion with screw diameter 26 mm and L/D 40.

The proportion of the ingredients for the inventive polyolefin compositions are provided in the table below. Once the polyolefin compositions were obtained, melt flow rate and density were measured as shown below. The melt flow rate (MFR) was measured at 190° C. at 2.16 kg in accordance with the standard ASTM D1238 (2013) and density was measured in accordance with the standard ASTM D792 (2008).

TABLE 2

| Components | POC1 | POC2 | POC3 | POC4 | POC5 | POC6 | POC7 |
|---|---|---|---|---|---|---|---|
| POE/OBC | 95% | 90% | 80% | 95% | 90% | 100% | 100% |
| | (C0560D) | (C0560D) | (C0560D) | (C0560D) | (C0560D) | (C0570D) | (OBC) |
| HDPE | 5% | 10% | 20% | 5% | 10% | 0.0 | 0.0 |
| | (B5429) | (B5429) | (B5429) | (CC453) | (CC453) | | |
| MFR | 0.43 | 0.43 | 0.43 | 0.5 | 0.52 | 0.50 | 1.02 |
| (g/10 min) | | | | | | | |
| Density | 867.3 | 872.3 | 880.7 | 867.7 | 872.7 | 868 | 866 |
| (kg/m³) | | | | | | | |

### Example II

Purpose: Providing a set foam materials each having an Asker Type C Hardness of 45 units and derived from a set of foamable polyolefin compositions (FPOC). The inventive foam materials were prepared using a suitable combination of the polyolefin compositions described in Example I along with additives comprising a mineral filler, a blowing agent, a heat transfer agent, a processing aid, a cross-linking agent.

Material: The following materials were used for preparing the foamable polyolefin composition:

TABLE 3

| Additive | Specific material |
|---|---|
| Mineral filler | Talc, Liaoning Aihai Talc Co. Ltd, China |
| Blowing agent | Azodicarbonamide (ADCA) CAS No: 123-77-3 |
| Heat transfer agent | ZnO CAS No: 1314-13-2 |
| Processing aid | Stearic acid CAS No: 57-11-4 |
| Cross-linking agent | Dicumylperoxide (DCP) CAS No: 80-43-3 |
| Ethylene vinyl acetate copolymer | EVA7350, Formosa Plastics, Taiwan |

Method of preparation of inventive foam material: The compounding of the foam composition is as follows: Polymer pellets obtained from Example I, were added to a 1.5 liter, Banbury mixer. Filler additives comprising zinc oxide (ZnO), stearic acid, and talc were added to the Banbury after the polymer melted (around 5 minutes). The blowing agent (azodicarbonamide) and cross-linking agent (dicumylperoxide) were added last, after the fillers were uniformly dispersed, and the contents were mixed for another 3 to 5 minutes for a total mixing time of 15 minutes.

The batch temperature was checked by using a thermal probe detector right after the compounds were discharged. The precursor mixture was then placed between two roll mills (maintained at a temperature of about 120° C.) to carry out the milling operation and obtained what is termed as a foam precursor formulation. Thereafter, the foam precursor formulation was formed into a sheet (or roll milled blanket) of about 5 mm in thickness.

The foam manufacturing is detailed below. Roll milled blankets were cut into squares (three or four “6 inch×6 inch” squares), and placed inside a pre-heated foam mold of dimensions around 49 square inches. The surface of the chamber was sprayed with mold releasing agent, to avoid sticking of the foam to the chamber during de-molding.

Compression foaming process: The compression foaming process involved two compression foaming steps. First a preheating process was conducted to eliminate air pockets inside the sample and between the stacked blanket layers prior to curing. Thereafter, a second heating step to facilitate the curing/foaming process. The preheating was conducted for 8 minutes at 110° C., and pressed at 10 tons, for 4 minutes, to form a solid mass in the mold before foaming. The preheated mass was transferred to the foaming press, and held for 15 minutes at 24 MPa and 170° C. Once the pressure was released, the foam was removed quickly from the tray, and placed in a vent hood on several non-stick sheets, and the top side length was measured as soon as possible. The foam surfaces needed to be insulated from the bench top, using cardboard boxes. Insulating the surfaces of the newly made foam prevents uneven cooling on the top and bottom surface. The foams cool in the hood for 40 minutes following which they were transferred to a storage container, and allowed to cool for 24 hours. For the comparative formulations a similar approach was followed with the applicable ingredients.

TABLE 4
Foamable Polyolefin Compositions

| | FPOC1 | FPOC2 | FPOC3 | FPOC4 | FPOC5 |
|---|---|---|---|---|---|
| EVA7350 | 0.0 | 0.0 | 0.0 | 0.0 | 80.31 |
| Talc | 16.1 | 16.2 | 16.2 | 16.2 | 16.05 |
| ADCA (%) | 1.3 | 1.3 | 1.2 | 1.0 | 1.60 |
| DCP (%) | 0.6 | 0.6 | 0.6 | 0.6 | 0.64 |
| ZnO (%) | 0.6 | 0.6 | 0.6 | 0.6 | 0.6 |
| Stearic Acid (%) | 0.8 | 0.8 | 0.8 | 0.8 | 0.80 |
| Polyolefin Composition | 80.6 POC2 | 80.5 POC5 | 80.6 POC6 | 80.8 POC7 | 0.0 |
| (POC) from Example I | | | | | |
| (%) | | | | | |
| Ethylene alpha-olefin co- | 72.5 | 72.4 | 80.6 | 0.0 | 0.0 |
| polymer (A) derived from | | | | | |
| POC (%) | | | | | |
| Ethylene polymer (B) | 8.1 | 8.1 | 0 | 0 | 0.0 |
| derived from POC (%) | | | | | |

For the foamable polyolefin composition FPOC4, the polyolefin composition (POC7) was used, which was derived from the Olefin Block Copolymers (OBC) while the foamable polyolefin composition FPOC3, the polyolefin composition (POC6) was used, which was derived from the ethylene alpha-olefin co-polymer (A). The foamable polyolefin composition FPOC5, used ethylene vinyl acetate copolymer (EVA) and does not contain any polyolefin composition. The inventive foamable polyolefin compositions (FPOC1 and FPOC2) have comparable amount of polyolefin composition. However, polyolefin compositions POC2 and POC5 are derived from ethylene polymer (B) having different melt flow rate and therefore the POC2 and POC5 would impart different chemical and physical properties to the foam derived from such polyolefin compositions.

Results: The foamed specimen sample derived from the foamable polyolefin composition were subjected to the tests of Compression Set, Shrinkage, Falling Ball Rebound test or Resilience test, Tensile Strength, Peel Strength, Tear Strength and the results are as reported below.

TABLE 5
Test results of foams derived from Foamable Polyolefin Compositions

| | FPOC1 | FPOC2 | FPOC3 | FPOC4 | FPOC5 |
|---|---|---|---|---|---|
| Compression Set (%) | 64 | 71 | 67 | 63.5 | 69 |
| Shrinkage (%) | 3.0 | 5.0 | 3.0 | 2.8 | 2.5 |
| Falling Ball Rebound (Resilience) % | 58.0 | 62.0 | 60.0 | 57.0 | 41.0 |
| Tensile Strength (MPa) | 17.5 | 18.1 | 18.0 | 17.3 | 17.1 |
| Tear Strength (kN/m) | 12.3 | 13.0 | 13.3 | 12.6 | 12.0 |
| Peel Strength (kN/m) | 1.95 | 1.3 | 2.1 | 1.85 | 1.7 |

From the data provided in Table 5, it is evident that that the foams obtained from the inventive formulations have an excellent balance of foam properties (e.g. relatively low compression set, high resilience, low shrinkage) while retaining the desired mechanical properties related to tensile strength, tear and peel strength. For example, although the foam obtained from the formulation FPOC2 has a higher compression set, it's overall tensile and tear strength is higher in comparison to the foam derived from the comparative formulation FPOC4. However, the foam derived from the formulation FPOC2 demonstrates excellent resilience properties as compared to the other formulations. Similarly, the foam derived from the formulation FPOC1, has lower compression set as desired while retaining suitable mechanical properties of tensile strength and peel strength. From the results provided under Table 5, it is evident that the EVA based foam derived from the formulation FPOC5, the mechanical properties of tensile strength, tear strength and along with foam resilience properties are lower than that of the foams obtained from the inventive formulations FPOC1 and FPOC2.

It is also to be noted that for a foam to have the desired balance of foam properties (e.g. compression set, resilience) and mechanical properties (tensile strength), the content of polyolefin composition derived from Example I, may be maintained above 80.0 wt. % of the total weight of the foamable polyolefin composition.

### Example III

Purpose: Providing a set of foam material each having an Asker Type C Hardness of 50 units and derived from a set of foamable thermoplastic polymer compositions (FTPC). The foam materials were prepared using a suitable combination of the polyolefin compositions described in Example I and an ethylene vinyl acetate copolymer (EVA), along with additives comprising mineral filler, a blowing agent, a heat transfer agent, a processing aid, and a cross-linking agent.

The material details are identical to Example II, except that ethylene vinyl acetate copolymer (EVA) was used in additionally. The method of preparing the foamable composition is identical to that described in Example II except that ethylene vinyl acetate copolymer (EVA) was also used for preparing the foamable composition.

Details of the foamable composition is provided below:

TABLE 6
Foamable Thermoplastic Polymer Compositions

| | FTPC1 | FTPC2 | FTPC3 | FTPC4 | FTPC5 | FTPC6 | FTPC7 |
|---|---|---|---|---|---|---|---|
| EVA (%) | 64.42 | 64.42 | 64.42 | 64.42 | 64.42 | 64.42 | 64.45 |
| Talc (%) | 16.1 | 16.1 | 16.1 | 16.1 | 16.1 | 16.1 | 16.12 |
| ADCA (%) | 1.31 | 1.31 | 1.41 | 1.31 | 1.31 | 1.31 | 1.26 |
| DCP (%) | 0.64 | 0.64 | 0.64 | 0.64 | 0.64 | 0.64 | 0.64 |
| ZnO (%) | 0.6 | 0.6 | 0.6 | 0.6 | 0.6 | 0.6 | 0.6 |
| Stearic Acid (%) | 0.82 | 0.82 | 0.74 | 0.82 | 0.82 | 0.82 | 0.82 |
| Polyolefin | 16.11 | 16.11 | 16.09 | 16.11 | 16.11 | 16.11 | 16.11 |
| Composition (POC) | POC1 | POC2 | POC3 | POC4 | POC5 | POC6 | POC7 |
| from Example I (%) | | | | | | | |
| Total weight (%) | 100 | 100 | 100 | 100 | 100 | 100 | 100 |
| (Total Weight ~497 g) | | | | | | | |
| Ethylene alpha-olefin | 15.3 | 14.5 | 12.87 | 15.30 | 14.50 | 16.11 | 16.11 |
| copolymer (A) derived | | | | | | | |
| from POC (%) | | | | | | | |
| Ethylene polymer (B) | 0.81 | 1.61 | 3.22 | 0.81 | 1.61 | 0.0 | 0.0 |
| derived from POC (%) | | | | | | | |

Results: The foamed specimen sample derived from the foamable thermoplastic polymer compositions were subjected to the tests of Compression Set, Tensile Strength, Peel Strength, Tear Strength and the results are reported below:

TABLE 7
Test results of foams derived from Foamable Thermoplastic Polymer Compositions

| | FTPC1 | FTPC2 | FTPC3 | FTPC4 | FTPC5 | FTPC6 | FTPC7 |
|---|---|---|---|---|---|---|---|
| Compression Set (%) | 71.0 | 65.0 | 66.0 | 70.0 | 63.5 | 68.0 | 65.0 |
| Tensile Strength (MPa) | 19.5 | 19.7 | 19.0 | 19.0 | 20.0 | 19.8 | 18.5 |
| Tear Strength (kN/m) | 13.7 | 13.8 | 13.1 | 13 | 13.9 | 13.5 | 13.3 |
| Peel Strength (kN/m) | 2.15 | 2.13 | 2.05 | 2.11 | 2.17 | 2.1 | 2.0 |

From the data provided in Table 7, it is evident that that the foams obtained from the inventive formulations have an excellent balance of foam properties while retaining the desired mechanical properties related to tensile strength, tear and peel strength. For example, the foam derived from the inventive formulation (FTPC5) has as desired, nearly 11% lower compression set, compared to the compression set of the foam obtained from the comparative formulation (FTPC1) while also having higher mechanical properties of tensile strength. Similarly, although the foam obtained from formulation (FTPC2) has a comparable compression set with that of the foam derived from olefin block copolymer (FTPC7), the mechanical properties of tensile strength, tear or peel strength is higher for that of the foam derived from (FTPC2). It is also to be noted that for a foam to have the desired balance of compression set and mechanical properties, the ethylene alpha-olefin co-polymer (A) content may be maintained below 15.0 wt. % of the total foamable thermoplastic polymer composition.

### Example IV

Purpose: Providing a set of foam materials each having an Asker Type C Hardness of 55 and derived from foamable thermoplastic polymer compositions. The foam materials were prepared using a suitable combination of the polyolefin compositions described in Example I and an ethylene vinyl acetate copolymer (EVA), along with additives comprising a mineral filler, a blowing agent, a heat transfer agent, a processing aid, and a cross-linking agent.

The material details and method of preparation of the foam materials are identical to Example III, except that the blowing agent concentrations were adjusted in order to obtain a foam with a higher Asker Type C Hardness of 55 units.

Details of the foamable composition is provided below:

TABLE 8
Foamable Thermoplastic Polymer Compositions

| | FTPC8 | FTPC9 | FTPC10 | FTPC11 |
|---|---|---|---|---|
| EVA (%) | 64.49 | 64.45 | 64.49 | 64.52 |
| Talc (%) | 16.12 | 16.11 | 16.12 | 16.13 |
| ADCA (%) | 1.21 | 1.26 | 1.21 | 1.15 |
| DCP (%) | 0.64 | 0.64 | 0.64 | 0.64 |
| ZnO (%) | 0.60 | 0.60 | 0.60 | 0.60 |
| Stearic Acid (%) | 0.80 | 0.80 | 0.80 | 0.80 |
| Polyolefin Composition (POC) | 16.12 POC2 | 16.11 POC3 | 16.12 POC6 | 16.13 POC7 |
| from Example I (%) | | | | |
| Total weight (%) (Total Weight ~496 g) | 100 | 100 | 100 | 100 |
| Ethylene alpha-olefin co-polymer (A) derived from | 14.51 | 12.89 | 16.12 | 0 |
| POC (%) | | | | |
| Ethylene polymer (B) derived from POC (%) | 1.61 | 3.22 | 0 | 0 |

For the foamable thermoplastic polymer composition FTPC11, the polyolefin composition (POC7) was used, which was derived from the Olefin Block Copolymers (OBC) while the foamable polyolefin composition FTPC10, the polyolefin composition (POC6) was used, which was derived from the ethylene alpha-olefin co-polymer (A).

Results: The foamed specimen sample derived from the foamable thermoplastic polymer compositions were subjected to the tests of Compression Set, Tensile Strength, Peel Strength, Tear Strength and the results are reported as provided below:

TABLE 9
Test results of foams derived from Foamable
Thermoplastic Polymer Compositions

| | FTPC8 | FTPC9 | FTPC10 | FTPC11 |
|---|---|---|---|---|
| Compression Set (%) | 40.0 | 40.0 | 44.0 | 40.0 |
| Shrinkage (%) | 1.4 | 1.4 | 1.6 | 1.4 |
| Falling Ball Rebound | 59.0 | 56.0 | 55 | 59.5 |
| (Resilience) % | | | | |
| Tensile Strength (MPa) | 25.0 | 23.3 | 21.5 | 22.6 |
| Tear Strength (kN/m) | 17.3 | 17 | 15.6 | 16.3 |
| Peel Strength (kN/m) | 2.72 | 2.58 | 2.65 | 2.45 |

From the data provided in Table 9, it is evident that that the foams obtained from the inventive formulations have an excellent balance of foam properties (e.g. compression set, resilience, and shrinkage) while retaining the desired mechanical properties (related to tensile strength, tear and peel strength).

For example, the inventive foams derived from the foamable thermoplastic polymer formulations FTPC8 and FTPC9 have comparable compression set (40%) and shrinkage (1.4%) compared to the foam derived from the Olefin Block Copolymer (FTPC11). However, the foams derived from inventive foamable thermoplastic polymer formulations FTPC8 and FTPC9 have improved tensile strength, peel and tear strength in addition to the excellent foam properties. On the other hand, foams derived from the comparative foamable thermoplastic polymer formulation FTPC10, has a higher compression set, higher shrinkage and lower mechanical properties compared to the foams based on the inventive formulations and therefore has balance of properties lower than what is desired.

Accordingly, from the results obtained from the experimental data, it is evident that polyolefin compositions having a composition in accordance with the present invention when used for preparing foamable compositions, the resultant foams have improved balance of foam properties and mechanical properties.

1. A polyolefin composition, comprising:
a) ≥65.0 wt. % and ≤94.0 wt. %, of an ethylene alpha-olefin co-polymer (A), with regard to the total weight of the polyolefin composition, wherein the ethylene alpha-olefin co-polymer has at least one of:
i. a peak melting temperature of ≥35° C. and ≤90° C., when determined in accordance with ASTM D3418-15, using Differential Scanning calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle;
ii. ≥5.0 wt. % and ≤45.0 wt. %, of polymeric units derived from one or more alpha-olefins having 3-12 carbon atoms, with regard to the total weight of the ethylene alpha-olefin co-polymer;
iii. a melt flow rate (MFR) of ≥0.10 g/10 min and ≤30.0 g/10 min, when determined at 190° C. at 2.16 kg load in accordance with ASTM D1238 (2013); and
iv. a density of ≥850 kg/m³ and ≤900 kg/m³, when determined in accordance with ASTM D792 (2008); and
b) ≥6.0 wt. % and ≤35.0 wt. %, of an ethylene polymer (B), with regard to the total weight of the polyolefin composition, wherein the ethylene polymer (B) has at least one of:
i. a density of ≥940 kg/m³ and ≤980 kg/m³, when determined in accordance with ASTM D1505-10 (2018) at 23° C.; and
ii. a melt flow rate (MFR) of ≥0.03 g/10 min and ≤40.0 g/10 min, when determined at 190° C. at 2.16 kg load in accordance with ASTM D1238 (2013).

2. The polyolefin composition of claim 1, wherein the polyolefin composition has:
a) a density of ≥870 kg/m³, when measured in accordance with ASTM D792 (2008); and
b) a melt flow rate (MFR) of ≥0.35 and ≤0.80 g/10 min, when determined at 190° C. at 2.16 kg load in accordance with ASTM D1238 (2013).

3. A foamable polyolefin composition, comprising:
a) ≥70.0 wt. %, with regard to the total weight of the foamable polyolefin composition, of the polyolefin composition of claim 1; and
b) ≤30.0 wt. %, with regard to the total weight of the foamable polyolefin composition, of one or more additives selected from a blowing agent, a cross-linking agent, a mineral filler, a processing aid, a heat transfer agent, or combinations thereof.

4. The foamable polyolefin composition of claim 3, wherein the foamable polyolefin composition comprises:
a) ≥65.0 wt. % and ≤80.0 wt. %, of the ethylene alpha-olefin co-polymer (A);
b) ≥6.0 wt. % and ≤20.0 wt. %, of the ethylene polymer (B); and
c) ≥0.5 wt. % and ≤30.0 wt. %, of additives comprising a blowing agent, a cross-linking agent, a mineral filler, a processing aid, and a heat transfer agent;
with regard to the total weight of the foamable polyolefin composition.

5. A thermoplastic polymer composition, comprising:
a) ≥55.0 wt. % and ≤90.0 wt. %, of an ethylene vinyl acetate copolymer (EVA); and
b) ≥10.0 wt. % and ≤45.0 wt. %, of the polyolefin composition of claims 1-2, with regard to the total weight of the thermoplastic polymer composition.

6. A foamable thermoplastic polymer composition, comprising:
a) ≥65.0 wt. %, of the thermoplastic polymer composition of claim 5; and
b) ≤35.0 wt. %, of one or more additives selected from a blowing agent, a cross-linking agent, a mineral filler, a processing aid, a heat transfer agent, or combinations thereof,
with regard to the total weight of the foamable thermoplastic composition.

7. The foamable thermoplastic polymer composition of claim 6, wherein the foamable thermoplastic polymer composition comprises at least one of:
a) ≥0.1 wt. % and ≤25.0 wt. %, of a mineral filler;
b) ≥0.1 wt. % and ≤2.0 wt. %, of a cross-linking agent;
c) ≥0.1 wt. % and ≤5.0 wt. %, of a blowing agent;
d) ≥0.1 wt. % and ≤2.0 wt. %, of a processing aid;
e) ≥0.1 wt. % and ≤2.0 wt. %, of a heat transfer agent; and
f) combinations thereof;
with regard to the total weight of the foamable thermoplastic polymer composition.

8. The foamable thermoplastic polymer composition of claim 6, wherein the foamable thermoplastic polymer composition comprises:
a) ≥55.0 wt. % and ≤90.0 wt. %, of the ethylene vinyl acetate copolymer (EVA);
b) ≥9.0 wt. % and ≤15.0 wt. %, of the ethylene alpha-olefin co-polymer (A);
c) ≥1.0 wt. % and ≤10.0 wt. %, of the ethylene polymer (B); and
d) ≥0.5 wt. % and ≤35.0 wt. %, of additives comprising a blowing agent, a cross-linking agent, a mineral filler, a processing aid, and a heat transfer agent;
with regard to the total weight of the foamable thermoplastic polymer composition.

9. The foamable thermoplastic polymer composition of claim 6, wherein the foamable thermoplastic polymer composition comprises:
a) ≥55.0 wt. % and ≤70.0 wt. % of the ethylene vinyl acetate copolymer (EVA);
b) ≥9.0 wt. % and ≤15.0 wt. %, of the ethylene alpha-olefin co-polymer (A);
c) ≥1.0 wt. % and ≤5.0 wt. % of the ethylene polymer (B);
d) ≥12.0 wt. % and ≤18.0 wt. %, of talc;
e) ≥0.1 wt. % and ≤2.0 wt. %, of dicumylperoxide;
f) ≥0.1 wt. % and ≤5.0 wt. %, of azodicarbonamide;
g) ≥0.1 wt. % and ≤2.0 wt. %, of stearic acid; and
h) ≥0.1 wt. % and ≤2.0 wt. % of zinc oxide;
with regard to the total weight of the foamable thermoplastic polymer composition.

10. A foamed article comprising the polyolefin composition of claim 1.

11. A foamed article obtained by a process comprising the step of compression foaming the foamable polyolefin composition of claim 3.

12. A method of preparing the foamed article of claim 10, wherein the method comprises:
a) providing a foam precursor formulation comprising: the polyolefin composition of claim 1, a mineral filler, a blowing agent, a cross-linking agent, a heat transfer agent, a processing aid, and optionally an ethylene vinyl acetate copolymer; and
b) subjecting the foam precursor formulation to compression foaming to obtain the foamed article.

13. The method of claim 12, wherein the foam precursor formulation is prepared by a method comprising:
a) mixing a set of ingredients comprising the polyolefin composition of claim 1, the mineral filler, the heat transfer agent, the processing aid, the crosslinking agent, the blowing agent, and optionally the ethylene vinyl acetate copolymer, and forming a precursor mixture; and
b) milling the precursor mixture and forming the foam precursor formulation.

14. An article comprising the foamed article of claim 10.

15. (canceled)

16. The article of claim 14, wherein the article is a footwear midsole.

17. A foamed article comprising the thermoplastic composition of claim 5.

18. A foamed article obtained by compression foaming the foamable thermoplastic polymer composition of claim 6.
